(19) United States
(12) Patent Application Publication
(10) Pub. No.: US 2014/0375866 A1
(43) Pub. Date: Dec. 25, 2014

(54) Integrated Lens Stack

(71) Applicant: Palle Geltzer Dinesen, Shenzhen (CN)

(72) Inventor: Palle Geltzer Dinesen, Shenzhen (CN)

(73) Assignees: AAC ACOUSTIC TECHNOLOGIES (SUZHOU) CO., LTD., Suzhou (CN); AAC ACOUSTIC TECHNOLOGIES (SHENZHEN) CO., LTD., Shenzhen (CN)

(21) Appl. No.: 13/946,354

(22) Filed: Jul. 19, 2013

(30) Foreign Application Priority Data
Jun. 25, 2013 (CN) 201310272320.8

(51) Int. Cl. G02B 13/00; G02B 3/00

(52) U.S. Cl. CPC G02B 13/0085; G02B 3/0062
USPC 348/335

(57) ABSTRACT

Disclosed is an integrated lens stack manufactured by dicing a wafer. The integrated lens stack includes an image sensor, at least one lens modules located on the image sensor. Each of the lens modules has a top lens, a bottom lens, and a middle lens between the top lens and the bottom lens, the bottom lens including a first active area and a second active area opposite to the second active area for collecting light, respectively. A chamber is formed between the middle lens and the bottom lens and is a closed room. An area of the first active area is sufficiently smaller than an area of the second active area.

### FIELD OF THE INVENTION

The present invention generally relates to microelectronic imagers including stacked lens assemblies, and more particularly, to an integrated lens stack used in an imager.

### DESCRIPTION OF RELATED ART

Microelectronic imagers are used in digital cameras, wireless devices with picture capabilities, products with IR or UV sensors, and many other applications. Cell phones and Personal Digital Assistants (PDAs), for example, often have microelectronic imagers for capturing and sending pictures. The growth rate of microelectronic imagers has been steadily increasing as they become smaller and produce better images with higher pixel counts.

Manufacture of optical elements by replication techniques, such as embossing or molding, is known. Of special interest for a cost effective mass production are wafer-scale manufacturing processes where an array of optical elements, e.g. lenses, is fabricated on a disk-like wafer by means of replication. In most cases, two or more wafers with optical elements attached thereto are stacked in order to form a wafer scale package where optical elements attached to different substrates are aligned. Subsequent to replication, this wafer structure can be separated into individual optical devices (dicing).

A wafer or substrate in the meaning used is a disc or a rectangular plate or a plate of any other shape of any dimensionally stable, often transparent material. The diameter of a wafer disk is typically between 5 cm and 40 cm, for example between 10 cm and 31 cm. Often it is cylindrical with a diameter of either 2, 4, 6, 8 or 12 inches, one inch being about 2.54 cm. The wafer thickness is for example between 0.2 mm and 10 mm, typically between 0.4 mm and 6 mm. The subsequent dicing step of the wafer then yields many individual optical devices.

Typically, an integrated optical device includes at least two optical elements stacked together along the general direction of light propagation. The light travelling through the optical elements from one side of the optical element to the other side of the optical element is substantially parallel to the optical axis, such that an optical boundary of the side is nearly as large as an optical boundary of the other side of the optical element. While the optical device is diced to fit with an array camera image sensor, an aperture will be provided at a side of the optical device. As the dicing process of the optical device is a process that generates dust and chip, the dust enables penetrating the aperture. It will need an extra process to clean the optical device, which limits the structure of the optical device, and leads to increased cost.

### BRIEF DESCRIPTION OF THE DRAWINGS

Many aspects of the exemplary embodiments can be better understood with reference to the following drawings. The components in the drawings are not necessarily drawn to scale, the emphasis instead being placed upon clearly illustrating the principles of the embodiments.

FIG. 1 is a schematic cross-sectional view of an integrated lens stack in accordance with a first embodiment of the present invention;

FIG. 2 is a schematic cross-sectional view of a lens module of an integrated lens stack in accordance with a second embodiment of the present invention; and

FIG. 3 is a schematic of a top view of a bottom lens of the integrated lens stack shown in FIG. 2.

### DETAILED DESCRIPTION OF THE EXEMPLARY EMBODIMENTS

Reference will now be made to describe the exemplary embodiments of the present disclosure in detail.

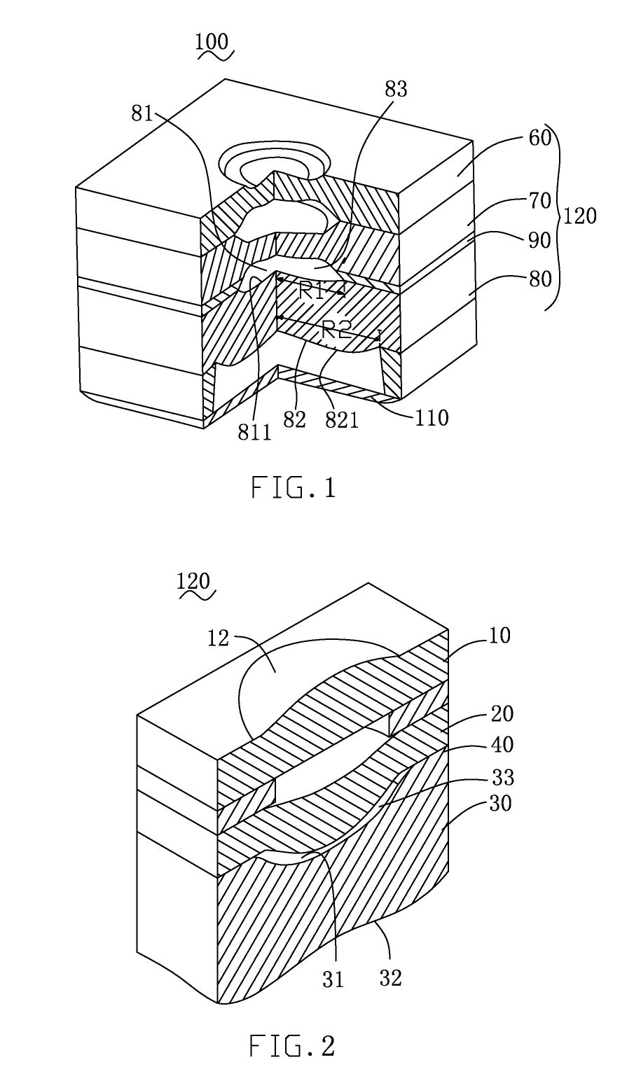

Referring to FIG. 1, an integrated lens stack 100 is manufactured by dicing a wafer in accordance with a first exemplary embodiment of the present disclosure and comprises an image sensor 110, at least one lens module 120 arranged above the image sensor 110. The lens module 120 includes a top lens 60, a bottom lens 80, and a middle lens 70 between the top lens 60 and the bottom lens 80. In the embodiment, FIG. 1 illustrates that the middle lens 70 is one piece, but, the amount of the piece is not limited to one. Furthermore, the module 120 further includes a spacer 90 arranged between the middle lens 70 and the bottom lens 80. Thus, an annular chamber 83 is formed between the middle lens 70 and the bottom lens 80 and the chamber is a closed (air tight) room. Alternatively, the annular chamber may be formed by being surrounded by the middle lens together with the bottom lens. In addition, the bottom lens 80 includes an upper surface 81, a lower surface 82 opposite to the upper surface 82, a first active area 811 and a second active area 821 separately arranged on the upper surface 81 and the lower surface 82 for collecting light, respectively. An area of the first active area 811 is sufficiently smaller than an area of the second active area 821. In other words, the light passes through the bottom lens 80 at an angle oblique to an optical axis of the lens module 120. The first active area 811 and the second active area 821 are circular in cross section. A radius R1 of the first active area 811 is smaller than a radius R2 of the second active area 821.

The image sensor 110 is used for collecting light from the corresponding lens module 120. The image sensor is a necessary component to manufacture a finished integrated lens stack. The image sensor can be obtained in the public-known arts. The shapes, forms, engaging relationships, and sizes of the element of the image sensor do not affect the engagement of the lens module.

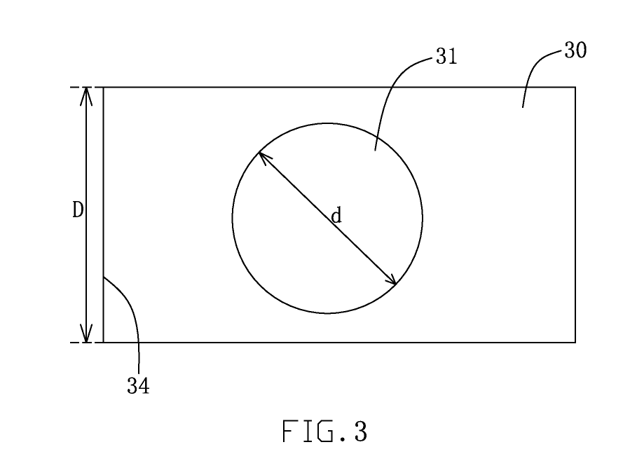

A second embodiment of the present disclosure is shown in FIGS. 2-3. A lens module 120 is used for realizing as a wafer-level lens module having a square or rectangular cross section. The lens module 120 comprises a top lens 10, a bottom lens 30, and a middle lens 20 between the top lens 10 and the bottom lens 30. A closed chamber 33 is formed by the middle lens 20 together with the bottom lens 30. A top active area 12 is disposed on the top lens 10 for collecting light. Similarly, a first active area 31 and a second active area 32 are disposed at the both side of the bottom lens 30, respectively. A minimum distance from any point at the most outer edge of the first active area 31 to an optical axis of the bottom lens 30 is smaller than a minimum distance from any point at the most outer edge of the second active area 32 to an optical axis of the bottom lens 30. Referring to FIG. 3, the first active area 31 is circular. A diameter d of the first active area 31 is smaller than a length D of the shortest side 34 of the bottom lens 30 in cross section. While the lens module 120 is diced for manufacturing into array camera, the closed chamber 33 is still maintained intact.

While the present invention has been described with reference to the specific embodiments, the description of the invention is illustrative and is not to be construed as limiting the invention. Various of modifications to the present invention can be made to the exemplary embodiments by those skilled in the art without departing from the true spirit and scope of the invention as defined by the appended claims.

What is claimed is:

1. An integrated lens stack comprising:
an image sensor ;
at least one lens modules located at the image sensor, and defining a top lens, a bottom lens, and a middle lens between the top lens and the bottom lens, the bottom lens including a first active area and a second active area opposite to the second active area for collecting light, respectively;
a chamber formed between the middle lens and the bottom lens; wherein:
the chamber is a closed room, and
an area of the first active area is sufficiently smaller than an area of the second active area.

2. The integrated lens stack as described in claim 1, wherein the first active area and the second active area are circular in cross section, and a radius of the first active area is smaller than a radius of the second active area.

3. The integrated lens stack as described in claim 1, wherein a minimum distance from any point at the most outer edge of the first active area to an optical axis of the bottom lens is smaller than a minimum distance from any point at the most outer edge of the second active area to an optical axis of the bottom lens.

4. The integrated lens stack as described in claim 1, wherein the first active area is circular, and a diameter of the first active area is smaller than a length of the shortest side of the bottom lens of the lens module in cross section.

5. The integrated lens stack as described in claim 1, wherein the lens module further has a spacer provided between the middle lens and the bottom lens.

6. The integrated lens stack as described in claim 5, wherein the chamber is surrounded by the middle lens together with the spacer and the bottom lens.
